(19) United States
(12) Patent Application Publication
(10) Pub. No.: US 2010/0209805 A1
(43) Pub. Date: Aug. 19, 2010

(54) MEMBRANE ELECTRODE ASSEMBLY HAVING PROTECTIVE BARRIER LAYER AND METHOD FOR MITIGATING MEMBRANE DECAY

(75) Inventors: Shruti Modi Gupta, Windsor, CT (US); Tommy Skiba, East Hartford, CT (US); Sathya Motupally, Milford, CT (US)

Correspondence Address: BACHMAN & LAPOINTE, P.C., 900 CHAPEL STREET, SUITE 1201, NEW HAVEN, CT, 06510, US

(73) Assignee: UTC POWER CORPORATION, South Windsor, CT (US)

(21) Appl. No.: 12/445,741

(22) PCT Filed: Oct. 24, 2006
(86) PCT No.: PCT/US06/41597

§ 371 Date: Apr. 16, 2009

(51) Int. Cl. H01M 8/10

(52) U.S. Cl. 429/483

(57) ABSTRACT

A membrane electrode assembly (10) includes an anode (16); a cathode (14), a membrane (12) between the anode and the cathode; and a protective barrier layer (22) between the membrane and at least one of the anode and the cathode, the protective barrier layer being adapted to restrict migration of at least one of oxygen and hydrogen from the anode and/or cathode to the membrane. The barrier layer keeps a plane of polarized charge (Xo) outside of the membrane and helps avoid formation of disconnected catalyst.

### BACKGROUND OF THE DISCLOSURE

The disclosure relates to fuel cells and, more particularly, to PEM fuel cells and reduction in degradation of the membrane of same.

In a PEM fuel cell, various mechanisms can cause peroxide to form or exist in the vicinity of the membrane. This peroxide can dissociate into highly reactive free radicals. These free radicals can rapidly degrade the membrane.

It is desired to achieve 40,000-70,000 hour and 5,000-10,000 hour lifetimes for stationary and transportation PEM fuel cells, respectively. Free radical degradation of the ionomer seriously interferes with efforts to reach these goals.

It is therefore the primary object of the present disclosure to provide a membrane electrode assembly which addresses these issues.

It is a further object of the disclosure to provide a method for operating a fuel cell which further addresses these issues.

Other objects and advantages appear herein.

### SUMMARY OF THE DISCLOSURE

In accordance with the present disclosure, the foregoing objects and advantages have been attained.

According to the disclosure, a membrane electrode assembly is provided which comprises an anode; a cathode; a membrane between the anode and the cathode; and a protective barrier layer between the membrane and at least one electrode of the anode and the cathode, the protective barrier layer being adapted to restrict migration of at least one of oxygen and hydrogen from the at least one electrode to the membrane. At least partially eliminating oxygen at the cathode side maintains a plane of potential change between the anode and the cathode outside the membrane. At least partially eliminating hydrogen on the anode side will keep hydrogen out of the membrane. This will minimize the amount of Pt islands that are formed away from Xo.

### BRIEF DESCRIPTION OF THE DRAWINGS

A detailed description of preferred embodiments of the present disclosure follows, with reference to the attached drawings, wherein:

FIG. 1 schematically illustrates a membrane electrode assembly including a cathode side protective barrier layer in accordance with the present disclosure;

FIG. 2 illustrates potential through a portion of the assembly due to the protective barrier layer of the present disclosure;

FIG. 3 illustrates ECA loss for a Nafion-based ionomer compared to a hydrocarbon, after potential cycling;

FIG. 4 shows a comparison of oxygen permeability measurements taken for a PFSA-based ionomer compared to a hydrocarbon (HC) ionomer membrane; and

FIG. 5 shows an embodiment of the present disclosure wherein a protective barrier layer is positioned between the membrane and the anode.

### DETAILED DESCRIPTION

The disclosure relates to fuel cells and, more particularly, to polymer electrolyte membrane (PEM) fuel cells, and to mitigating decay or degradation of such fuel cells.

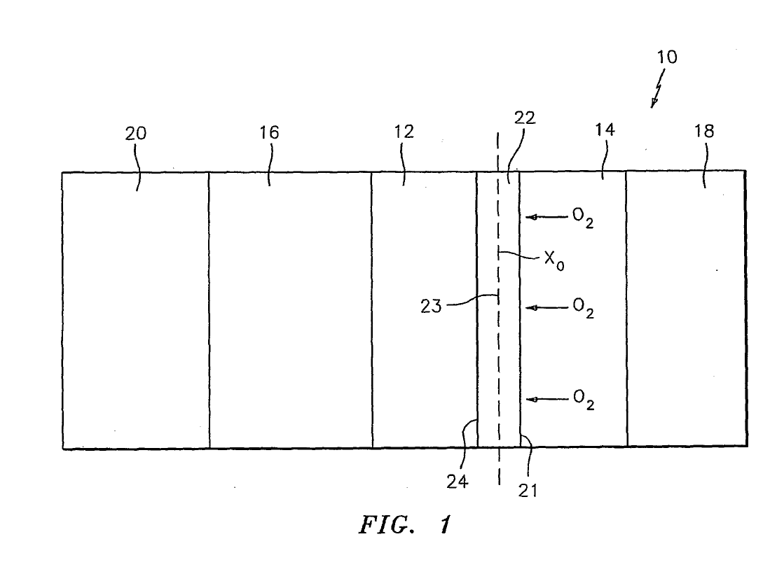

FIG. 1 schematically illustrates a membrane electrode assembly (MEA) 10 in accordance with the disclosure. As shown, assembly 10 includes a membrane 12, a cathode 14, an anode 16, and gas diffusion layers 18, 20. According to the disclosure, a protective barrier layer 22 is also provided, in this embodiment between membrane 12 and cathode 14. Barrier layer 22 is further described below.

Cathode 14 and anode 16 are positioned to either side of membrane 12 as shown, with gas diffusion layers 18, 20 positioned to either side of the electrodes (cathode 14 and anode 16).

Membrane electrode assembly 10 is operated by feeding oxygen in some form through gas diffusion layer 18 to cathode 14 and by feeding hydrogen in some form through gas diffusion layer 20 to anode 16. These reactants support generation of an ionic current across membrane 12 as desired.

Cathode 14 is a porous layer containing a suitable cathode catalyst and typically having a porosity of at least about 30%. Anode 16 is similarly a porous layer containing suitable anode catalyst, and also typically having a porosity of at least about 30%.

During operation of MEA 10, catalyst materials which are typically present within the electrodes, that is, within cathode 14 and/or anode 16, can dissolve and then precipitate elsewhere in the assembly. The precipitation is of two kinds. First, disconnected catalyst particles, for example particles of platinum, are deposited all through the membrane. This is a result of dissolved Pt in the membrane reacting with crossover hydrogen. These precipitated Pt particles can have a deleterious impact on the membrane by catalyzing reactions of crossover oxygen to generate reactive radicals that attack the membrane structure.

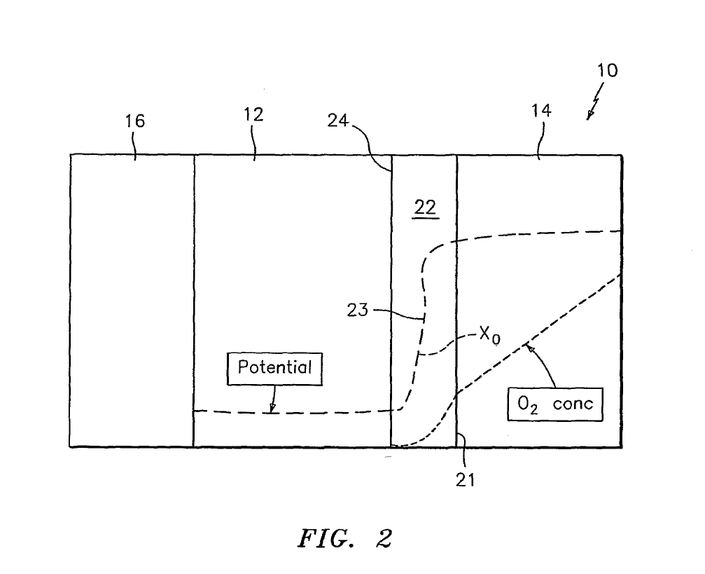

Second, there is a plane of polarized charge, or sharp potential change between the electrodes, and this plane is referred to herein as a plane of potential change, and/or as Xo, and is shown in FIGS. 1 and 2 at reference number 23. At Xo 23, reaction potential abruptly shifts from a low value to a high value. The position of Xo 23 depends heavily on the oxidant and reductant gas concentrations at locations on either side of Xo 23. If electrically isolated catalyst particles are present at Xo 23, this is a very likely position for formation of peroxide and/or generation of radicals which can have a deleterious effect upon membrane 12 and other ionomer present within assembly 10.

It has further been found that dissolved catalyst metal tends to precipitate or deposit at Xo 23, and that this deposited metal can increase the chance of formation of peroxide. Peroxide has been found to be directly responsible for degradation of membrane 12, because peroxide under certain conditions can break down to form radicals which react with the membrane and then carry portions of the membrane out of assembly 10 through exhaust from same. Also, radicals may form directly on such catalyst precipitates from the reaction of crossover gases and/or peroxide, which proceed to degrade the membrane.

During electrical load cycling of assembly 10 in a fuel cell, the amount of reactants varies and the position of Xo can move. When this happens, there is increased tendency toward dissolution of catalyst metal from the previous Xo location to the new Xo location. This is because after a certain amount of time of operation, sufficient metal deposits at Xo 23 that there is less driving force for dissolution. However, when Xo 23 moves, additional dissolution of catalyst can take place from both the electrodes and from catalyst particles already deposited in the membrane. Such a process can be especially damaging to the membrane due to the high specific area of catalyst surface that results.

The present disclosure is directed to controlling the location of Xo 23 to ensure that it resides in a location where damage to MEA 10 does not occur. The most desirable location for Xo 23 is in the catalyst layers where abundant Pt is present, or within the protective barrier layer itself.

As set forth above, in accordance with the disclosure, a protective barrier layer 22 is utilized to keep oxidant and reductant gas concentrations transitioning on opposite sides of layer 22. This serves to keep Xo 23 at a desired position, within layer 22, during operation.

According to the disclosure, several embodiments of protective layer 22 are provided, each of which serves to restrict migration of hydrogen and oxygen. Oxygen migration is restricted by layer 22 at the side of layer 22 which faces the cathode, and hydrogen migration is restricted by layer 22 at the other side. Restricting migration in this manner results in the transition of concentration of reactants falling inside the protective barrier layer as desired, and this results in Xo 23 remaining outside the membrane, and preferably within the protective barrier layer.

According to the disclosure, barrier layers are provided which are substantially non-porous. These layers are less permeable to hydrogen and oxygen than the adjacent electrodes, and therefore physically restrict such reactants and accomplish the goal of controlling location of Xo 23. Preferably, the protective barrier layer has a permeability to reactant gasses which is at least 80% less than the permeability of the adjacent electrode.

Protective barrier layer 22 serves to restrict flow of oxygen at the interface 21 between layer 22 and cathode 14. Protective barrier layer 22 further serves to restrict flow or diffusion of hydrogen at the interface 24 between membrane 12 and layer 22.

Protective layer 22 has a porosity which is less than that of the adjacent electrode. Protective layer 22 further preferably has a porosity of less than about 10%, and is preferably substantially non-porous (substantially 0% porosity).

Any porosity of protective barrier layer 22 should advantageously be flooded during operation, for example with water, to prevent oxygen diffusion through protective barrier layer 22. A layer 22 having porosity which is flooded with water during normal operation is considered to be non-porous as used herein since the water-filled porosity is effectively non-porous to reactant gasses. Thus, a porous layer 22 which during operation has the porosity filled with water or other reactant liquids is considered to be a suitable layer 22 according to the disclosure.

Provision of a protective barrier layer 22 having these properties advantageously results in at least partially eliminating migration of oxygen at interface 21. This help keeps Xo 23 within layer 22, and outside of membrane 12, during operations.

Protective barrier layer 22 in this embodiment can advantageously be provided as an electrically connected and ionically conductive structure having a porosity of less than about 10%, and preferably substantially 0%. Electrically connecting the layer 22 is necessary when catalyst particles are included in the layer howerver Barrier layer 22 is preferably substantially free of catalyst.

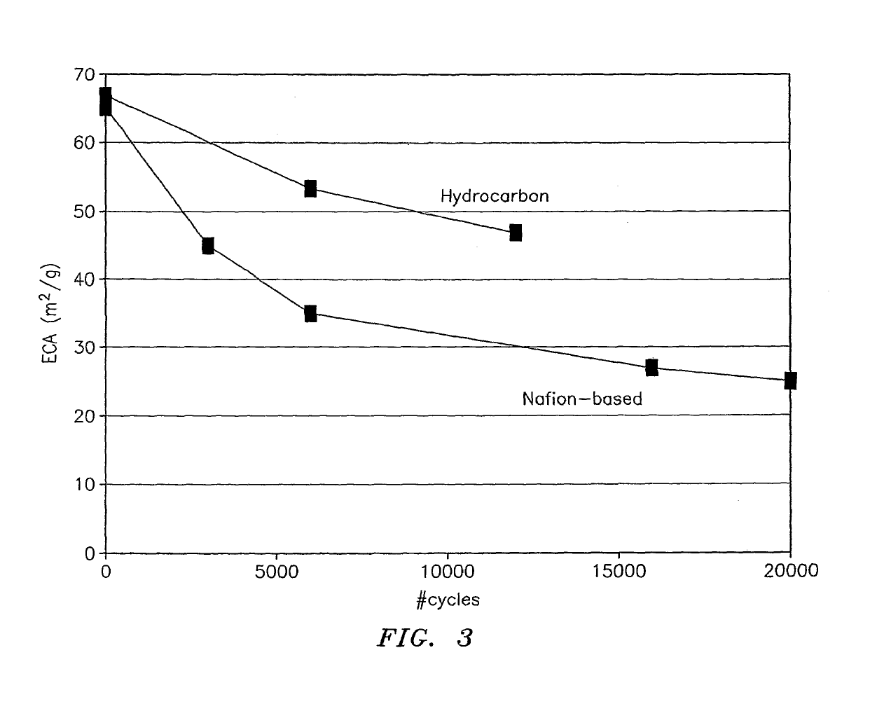

Protective barrier layer 22 can be formed using hydrocarbon ionomer material. This is desirable because it has been found that this material is highly useful in reducing catalyst dissolution and reactant gas crossover, and also has excellent mechanical strength. FIG. 3 demonstrates the reduced propensity for hydrocarbon ionomers versus Nafion (PFSA) based ionomers for catalyst dissolution, where the electrochemical catalyst area (ECA) is reduced for a hydrocarbon versus Nafion-based membrane electrode assemblies when subjected to a protocol that repeatedly cycles the cathode potential.

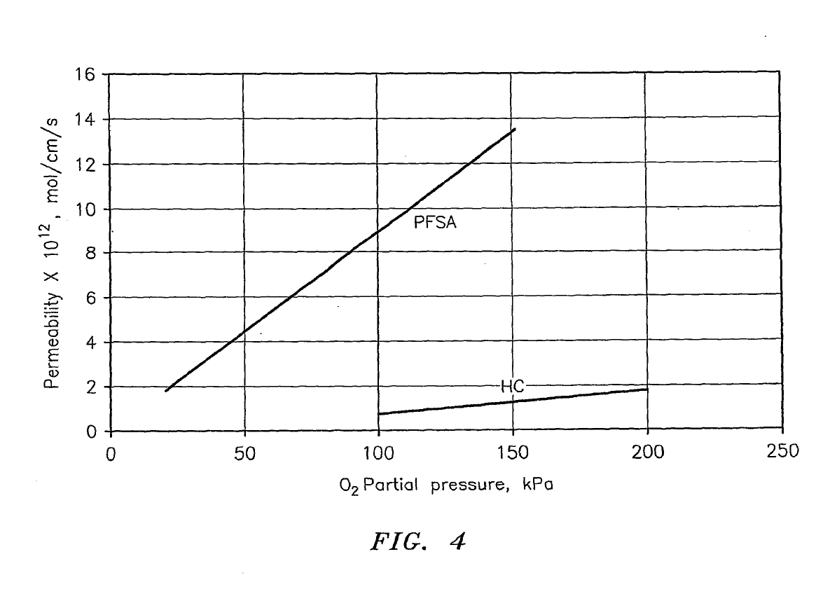

FIG. 4 further shows oxygen permeability measurements for PFSA versus HC based PEM membranes, where the HC ionomer shows diminished oxygen permeability over a range of pressures. Hydrocarbon materials can therefore be used to produce a layer which is both resistant to the dissolution of catalyst materials, and substantially non-porous to hydrogen and oxygen gasses. Such a layer thereby at least partially eliminates or presents a barrier to reactants and through this mechanism also serves to position Xo 23 as desired. The mechanical strength properties are also useful in that hydrocarbon ionomer material can itself be the ionomer used in protective layer 22, or can be mixed into other desired ionomer materials during the preparation of protective layer 22.

When made from hydrocarbon ionomer, protective barrier layer 22 preferably has a thickness of between about 0.01 and about 20 micrometers. Of course, barrier layers made from other materials may have different preferred thicknesses.

As used herein, hydrocarbon ionomers refer collectively to ionomers having a main chain which contains hydrogen and carbon, and which may also contain a small mole fraction of hetero atoms such as oxygen, nitrogen, sulfur, phosphorus, and/or fluorine. Such hydrocarbon materials are fully set forth in co-pending and commonly owned International Application number PCT/US05/39196, filed Oct. 27, 2005. The aforesaid application is incorporated herein in its entirety by reference. These hydrocarbon ionomers primarily include aromatic and aliphatic ionomers.

Examples of suitable aromatic ionomers include but are not limited to sulfonated polyimides, sulfoalkylated polysulfones, poly(p-phenylene) substituted with sulfophenoxy benzyl groups, and polybenzimidazole ionomers.

Non-limiting examples of suitable aliphatic ionomers are those based upon vinyl polymers, such as cross-linked polystyrene sulfonic acid), poly(acrylic acid), poly(vinylsulfonic acid), poly (2-acrylamide-2-methylpropanesulfonic acid) and their copolymers.

A hydrocarbon protective barrier layer can be used with or without catalyst. Since the primary mechanism of such a layer is to at least partially eliminate gas flow or permeation, the catalyst is of less importance and can be avoided altogether if desired. Since such catalyst leads to extra cost, it may be preferred to use hydrocarbon protective layers which have no catalyst unless other reasons exist to use a catalyst.

As set forth above, providing protective barrier layer 22 between cathode 14 and membrane 12 advantageously serves to define Xo 23 within cathode 14 or barrier layer 22 as desired, thereby allowing for reduced chance of catalyst driven generation of peroxide and catalyst driven formation of radicals, and also minimizing movement of Xo 23 during cycling of the cell, such that a sink of catalyst material can be initially provided in barrier layer 22, or initially deposited in barrier layer 22 during early operation, to thereby reduce or eliminate the driving force for catalyst dissolution. Of course if Xo 23 resides in the cathode, catalyst material is already present in that location.

Protective barrier layer 22 can be provided using various ionomer materials as discussed above, and advantageously serves to force Xo 23 to stay outside the membrane.

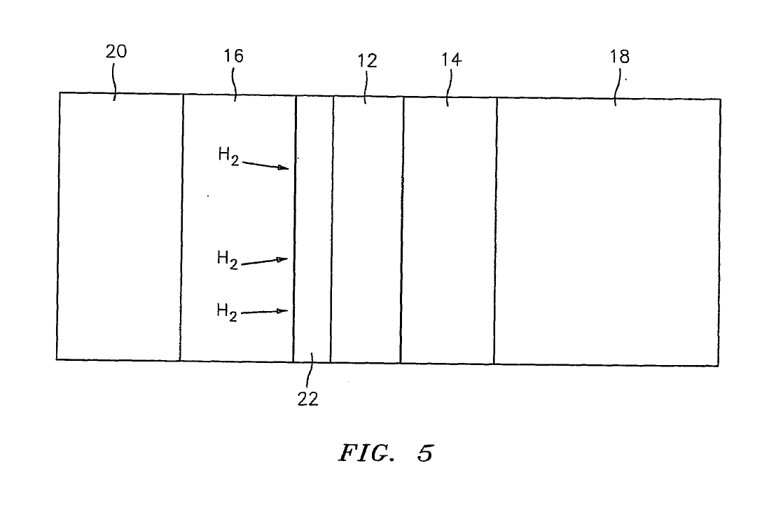

Turning to FIG. 5, in accordance with a further embodiment of the disclosure, protective barrier layer 22 can be positioned between anode 16 and membrane 12. In this location, layer 22 functions in similar manner to the function of layer 22 when positioned between membrane 12 and cathode 16. When the protective layer is in this position, it acts as a hydrogen barrier layer, and such a layer can be positioned either alone or in addition to layer 22 in the position shown in FIG. 1.

As stated above, crossover hydrogen can interact with dissolved catalyst to produce islands of disconnected catalyst in the assembly. Such islands can lead to formation of the radicals discussed above. A barrier layer on the anode side serves to prevent this hydrogen crossover and, thereby, prevent deposit of disconnected islands of catalyst in the assembly, and especially in the membrane.

In addition to acting as a barrier to flow of reactants, hydrocarbon ionomer also provides a protective barrier layer 22 with excellent durability. This durability can be usefully incorporated into membrane 12 as well. Thus, according to the disclosure, membrane 12 can advantageously be provided as a blended per-fluorinated and hydrocarbon ionomer. Such a membrane could be used in any of a wide variety of fuel cell applications, including but not limited to those illustrated herein.

In further accordance with the disclosure, protective barrier layer 22 can be provided as a combined hydrocarbon and per-fluorinated ionomer based layer (such as Nafion), for example by substantially homogeneously blending hydrocarbon in liquid ionomer or particulate form into the per-fluorinated ionomer-based material.

It should be noted that the subject matter of the present disclosure can advantageously be utilized in connection with various membranes including but not limited to reinforced membranes.

It should be appreciated that the barrier layer according to the disclosure, positioned between the membrane and the cathode (FIG. 1), between the membrane and the anode (FIG. 5), or both, advantageously serves to control the location of Xo and to discourage migration of dissolved catalyst to location where such catalyst can cause cell degradation, and to discourage deposit of disconnected catalyst particles in the membrane.

While the present disclosure has been described in the context of specific embodiments thereof, other alternatives, modifications, and variations will become apparent to those skilled in the art having read the foregoing description. Accordingly, it is intended to embrace those alternatives, modifications, and variations as fall within the broad scope of the appended claims.

What is claimed:

1. A membrane electrode assembly, comprising:
an anode;
a cathode;
a membrane between the anode and the cathode; and
a protective barrier layer between the membrane and at least one electrode of the anode and the cathode, the protective barrier layer being adapted to restrict migration of at least one of oxygen and hydrogen from the at least one electrode to the membrane.

2. The assembly of claim 1, wherein the protective barrier layer is between the membrane and the cathode and is substantially less permeable to oxygen than the cathode, whereby a plane of potential change between the anode and the cathode is within the protective barrier layer or the cathode.

3. The assembly of claim 1, wherein the protective barrier layer is between the membrane and the anode is substantially less permeable to hydrogen than the anode, whereby hydrogen crossover to the membrane is prevented.

4. The assembly of claim 1, wherein the protective barrier layer comprises a cathode side barrier layer between the membrane and the cathode, and an anode side barrier layer between the membrane and the anode.

5. The assembly of claim 1, wherein the protective barrier layer has a porosity of less than 10%.

6. The assembly of claim 1, wherein the protective barrier layer is substantially non-porous.

7. The assembly of claim 1, wherein the protective barrier layer comprises a layer having porosity, wherein during normal operating conditions the porosity is filled with reactant liquids.

8. The assembly of claim 1, wherein the protective barrier layer comprises a layer having porosity, wherein during normal operating conditions the porosity is filled with water.

9. The assembly of claim 1, wherein the protective barrier layer comprises a material selected from the group consisting of hydrocarbon ionomers, ionomers which are not per-fluorinated, and ionomers having an inorganic main chain, wherein said material is substantially non-porous to at least one of hydrogen and oxygen.

10. The assembly of claim 1, wherein the protective barrier layer comprises a material selected from the group consisting of hydrocarbon ionomers, ionomers which are not per-fluorinated, and ionomers having an inorganic main chain, said material is substantially less permeable to at least one of hydrogen and oxygen than the at least one electrode.

11. The assembly of claim 9, wherein the material is hydrocarbon ionomer.

12. The assembly of claim 9, wherein the material is ionomer which is not per-fluorinated.

13. The assembly of claim 9, wherein the material is ionomer having an inorganic main chain.

14. The assembly of claim 1, wherein the protective barrier layer comprises a blend of per-fluorinated ionomer and hydrocarbon ionomer.

15. A method for protecting a membrane of a membrane electrode assembly having an anode, a cathode, and the membrane between the anode and the cathode, comprising keeping a plane of potential change (Xo) outside of the membrane.

16. The method of claim 15, wherein the plane of potential change (Xo) is kept outside the membrane by restricting migration of oxygen to the membrane from the cathode.

17. A method for protecting a membrane of a membrane electrode assembly having an anode, a cathode and the membrane between the anode and the cathode, comprising preventing formation of disconnected catalyst particles in the membrane.

18. The method of claim 17, wherein disconnected catalyst particles are prevented from forming in the membrane by restricting migration of hydrogen to the membrane from the anode.
